(19) United States
(12) Patent Application Publication
(10) Pub. No.: US 2026/0064819 A1
(43) Pub. Date: Mar. 5, 2026

(54) DETERMINATION METHOD, RECORDING MEDIUM, AND INFORMATION PROCESSING APPARATUS

(71) Applicant: Fujitsu Limited, Kawasaki-shi (JP)

(72) Inventors: Akira KAMANO, Kawasaki (JP); NARISHIGE ABE, Kawasaki (JP)

(73) Assignee: Fujitsu Limited, Kawasaki-shi (JP)

(21) Appl. No.: 19/383,235

(22) Filed: Nov. 7, 2025

Related U.S. Application Data
(63) Continuation of application No. PCT/JP2023/017686, filed on May 11, 2023.

(51) Int. Cl. G06F 21/32; G06T 7/70; G06V 10/74

(52) U.S. Cl. CPC G06F 21/32; G06T 7/70; G06V 10/761; G06V 2201/07

(57) ABSTRACT

A determination method executed by a computer, the determination method including calculating an overlap degree between a first person and another person among a plurality of persons, in response to detecting that the plurality of persons are appearing in an image obtained by capturing a predetermined space; determining whether or not a partial image included in the image and indicating the first person is to be a target of person determination, according to the calculated overlap degree; determining which of candidates the first person is, by using the partial image, in response to determining that the partial image is to be the target of the person determination; and preventing the determining of which of the candidates the first person is, by using the partial image, in response to determining that the partial image is not to be the target of the person determination.

### CROSS-REFERENCE TO RELATED APPLICATION

The present application is a continuation application of International Application No. PCT/JP2023/017686 filed on May 11, 2023, the entire contents of which are incorporated herein by reference.

### FIELD

The embodiments discussed herein are related to a determination method, a recording medium, and an information processing apparatus.

### BACKGROUND

In a service such as payment using biometric authentication, there is a need for a smooth service that eliminates the need for user operation for authentication by constantly authenticating a person by using a video camera. As a technique for such a service, a technique referred to as person re-identification is known. In the following description, this technique of person re-identification will be referred to as “ReID”.

In ReID, the similarity between a person image (query person image) acquired by detecting and tracking a person image with respect to video data obtained by a video camera, and a registered image for authentication of each candidate person, is calculated, and this similarity is defined as the identity certainty. ReID constantly performs identity authentication by using this identity certainty.

Several technologies related to such ReID are known (for example, see Patent Documents 1 to 4).

For example, an image recognition device is known which has excellent real-time performance and can robustly perform individual identification. This device acquires a relative azimuth relationship between first and second input region images obtained by imaging a person from different azimuths. Next, a feature of a first registration region image included in a registration region image group obtained by imaging the person or another person from at least three azimuths, is compared with a feature of a first input region image. Further, a feature of a second registration region image of the same person included in the registration region image group is compared with a feature of a second input region image to determine whether the person appearing in the first and second input region images and the person appearing in the first and second registration region images are the same person. Then, the first and second registration region images are selected so that the relative azimuth relationship between the first and second registration region images approaches the relative azimuth relationship between the first and second input region images.

Patent Document 1: Japanese Unexamined Patent Application Publication No. 2016-1447

Patent Document 2: Japanese Unexamined Patent Application Publication No. 2022-18808

Patent Document 3: U.S. Patent Application Publication No. 2020/0349348

Patent Document 4: U.S. Patent Application Publication No. 2021/0374973

### SUMMARY

According to an aspect of the embodiments, there is provided a determination method executed by a computer, includes calculating an overlap degree between a first person and another person among a plurality of persons, in response to detecting that the plurality of persons are appearing in an image obtained by capturing a predetermined space; determining whether or not a partial image included in the image and indicating the first person is to be a target of person determination, according to the calculated overlap degree; determining which of candidates the first person is, by using the partial image, in response to determining that the partial image is to be the target of the person determination; and preventing the determining of which of the candidates the first person is, by using the partial image, in response to determining that the partial image is not to be the target of the person determination.

The object and advantages of the invention will be implemented and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 is a diagram for explaining an outline of control based on the overlap of a person image;

FIG. 2 is a diagram illustrating an example of a functional configuration of an authentication device;

FIG. 3 is a diagram illustrating a functional configuration of a first example of an authentication system;

FIG. 4A is a diagram illustrating a first example of a method for acquiring information of a person located in a predetermined space;

FIG. 4B is a diagram illustrating a second example of a method for acquiring information of a person located in a predetermined space;

FIG. 5 is a flowchart illustrating processing contents of a first example of authentication control processing;

FIG. 6 is a diagram illustrating a functional configuration of a second example of an authentication system;

FIG. 7 is a diagram illustrating a change of a threshold used for determining the extent of an overlap degree;

FIG. 8 is a diagram illustrating a state transition between execution and prevention of identity authentication by changing a threshold;

FIG. 9 is a diagram illustrating a functional configuration of a third example of an authentication system;

FIG. 10 is a flowchart illustrating processing contents of an example of tracking processing;

FIG. 11 is a diagram illustrating a functional configuration of a fourth example of an authentication system;

FIG. 12 is a diagram illustrating an example of installation of a plurality of imaging units;

FIG. 13 is a diagram illustrating operation of an authentication integration unit;

FIG. 14 is a flowchart illustrating processing contents of an example of authentication integration processing.

FIG. 15 is a diagram illustrating a hardware configuration example of an information processing apparatus.

### DESCRIPTION OF EMBODIMENTS

In ReID, if occlusion occurs in a query person image, or if illumination or clothing of the person differs between the query person image and the image of the candidate person, the degree of similarity used as the identity certainty decreases. Therefore, a person who should have already been registered as a candidate person may be treated as a new candidate person.

Hereinafter, an embodiment will be described with reference to the drawings.

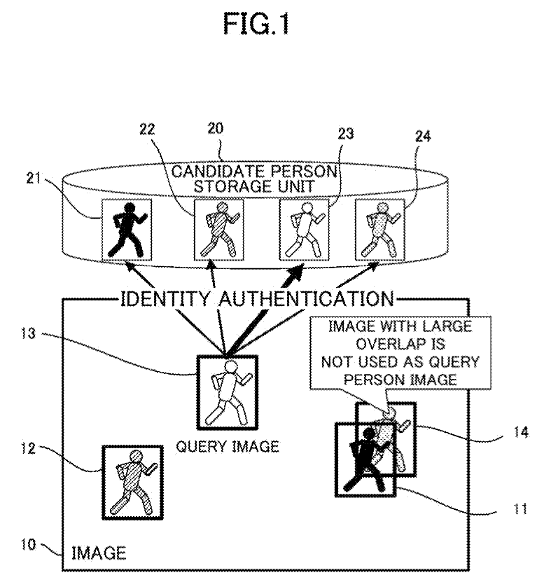

In the embodiment described below, in an authentication system for performing ReID, when excessive overlap occurs between a person image extracted from a video and another partial image, control is performed not to treat the person image as a query image. First, this control will be described with reference to FIG. 1.

In the present embodiment, a tracking process is performed on a rectangular frame (bounding box) surrounding an image of a person detected by a detection process for past time-series images, to estimate the position where the frame is located in the image 10. Then, the person detected by the detection process from the position on the image 10 closest to the estimated position is associated, as the same person, with the person of the image surrounded by the frame detected from the past time-series images.

In FIG. 1, the image 10 is one frame of a moving image (time-series image) obtained by capturing a predetermined space to be a target of authentication. The example of FIG. 1 illustrates a situation where the person images 11, 12, 13, and 14 surrounded by a rectangular frame (bounding box) are detected by the combination of the detection process for detecting the image of the person from the image 10 and the tracking process for the frame in the past moving images.

Further, in FIG. 1, a candidate person storage unit 20 stores, in advance, an image feature amount of a person who may be possibly appearing in the image 10. In the example of FIG. 1, it is assumed that the candidate person storage unit 20 stores an image feature amount of each of the candidate persons 21, 22, 23, and 24. Further, it is assumed that the candidate persons 21, 22, 23, and 24 correspond to persons indicated in the person images 11, 12, 13, and 14, respectively.

First, in the present embodiment, a case where ReID is performed by using the person image 13 in the example of FIG. 1 as a query image will be described.

In this case, first, the similarity between the image feature amount obtained from the person image 13 and the image feature amount of each of the candidate persons 21, 22, 23, and 24 stored in the candidate person storage unit 20 is calculated. The similarity between each of the candidate persons 21, 22, 23, and 24 calculated at this time is the identity certainty, that is, the certainty that the person indicated by the person image 13 is the actual person.

In the example of FIG. 1, because the person indicated by the person image 13 corresponds to the candidate person 23, the identity certainty of the candidate person 23 is the highest among the identity certainties of the candidate persons 21, 22, 23, and 24. Therefore, the person indicated by the person image 13 is the candidate person 23, is obtained as a result of the identity authentication.

Next, in the present embodiment, a case where ReID is performed by using the person image 14 in the example of FIG. 1 as a query image will be described.

In this case, first, similarity between the image feature amount obtained from the person image 13 and the image feature amount of each of the candidate persons 21, 22, 23, and 24 stored in the candidate person storage unit 20 is calculated. The similarity of each of the candidate persons 21, 22, 23, and 24 calculated at this time becomes the identity certainty indicating the certainty that the person indicated by the person image 14 is the actual person.

However, in the example of FIG. 1, occlusion occurs between the person indicated by the person image 14 and the person indicated by the person image 11, and the person image 14 largely overlaps the person image 11. In such a person image 14, the identity certainty, which is the similarity of the image feature amount with the candidate person 24 corresponding to the person indicated by the person image 14, becomes a small value. Therefore, as a result of the identity authentication, it may be erroneously assumed that any of the other candidate persons 21, 22, and 23 is the person indicated by the person image 14.

Therefore, in the present embodiment, when the overlap with respect to the person image 14 is large, the person image 14 is not treated as a query image, and execution of the identity authentication for determining whether the person of the person image 14 is any of the candidate persons 21, 22, 23, and 24, is prevented. As a result, the accuracy of the identity authentication is improved.

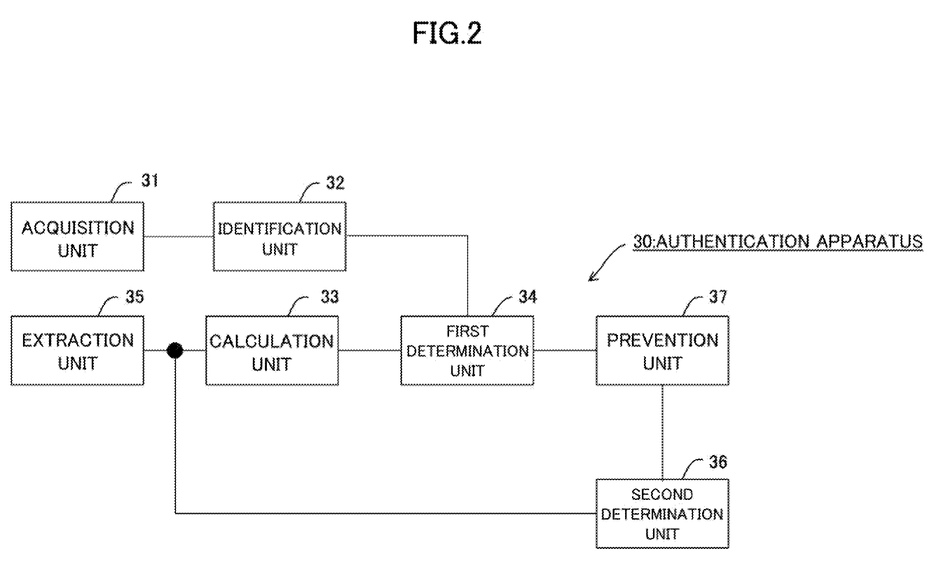

Next, FIG. 2 will be described. FIG. 2 illustrates an example of the functional configuration of an authentication apparatus 30. The authentication apparatus 30 is an apparatus for controlling identity authentication based on the overlap of the person images described above.

The authentication apparatus 30 includes an acquisition unit 31, an identification unit 32, a calculation unit 33, a first determination unit 34, an extraction unit 35, a second determination unit 36, and a prevention unit 37.

The acquisition unit 31 acquires information about a person present in a predetermined space.

The identification unit 32 identifies a person present in the predetermined space as a candidate of the person indicated by the query person image, based on the information about the person acquired by the acquisition unit 31.

The calculation unit 33 calculates the overlap degree between a first person and another person among a plurality of persons when the appearance of the plurality of persons is detected from an image 10 which is one frame of a moving image obtained by capturing a predetermined space in which information about a person entering and leaving the space is acquired by the acquisition unit 31.

According to the overlap degree calculated by the calculation unit 33, the first determination unit 34 determines whether or not the partial image included in the image 10 and indicating the first person is to be the target of person determination.

That is, the calculation unit 33 calculates the overlap degree between the partial image indicating the first person and the partial images indicating another person as the overlap degree, and the first determination unit 34 determines whether or not the partial image indicating the first person is to be treated as a query person image according to the overlap degree.

The extraction unit 35 extracts the partial image indicating the first person from the image 10. The extraction unit 35 performs this extraction based on a combination of the result of detecting the person image from the image 10 and the result of estimating the position of the partial image in the image 10 based on the position of the partial image in each of the past images 10 captured prior to the image 10.

In the present embodiment, the position, in the image 10, of a frame (bounding box) surrounding the image of the person detected by the detection processing for the past time-series images, is estimated by using a motion vector obtained from the position of the frame. Then, the image of the person detected by the detection processing for the image 10 is extracted from the image 10, from the position closest to the estimated position. Further, the person detected by the detection processing is associated, as the same person, with the person surrounded by the frame detected from the past time-series images, and the detected position of the person is the position of the frame on the image 10.

Note that the process of estimating the position of an element included in the image 10 based on a motion vector obtained from the position of the element in each of the time-series images prior to the image 10, is a general technique. Therefore, by using this technique, it is easily feasible to perform tracking in which the position of a partial image on the image 10 is estimated based on a motion vector obtained from the position of the partial image in each of the time-series images prior to the image 10. Also, the process of detecting a person image from the image 10 is a general technique. In the present embodiment, the function of the extraction unit 35 is implemented by using these techniques.

The second determination unit 36 performs identity authentication for determining which of the candidates the first person is, by using the partial image indicating the first person as the query person image.

The prevention unit 37 prevents the above-described identity authentication for determining which of the candidates the first person is, which is performed by the second determination unit 36, when the first determination unit 34 determines that the partial image indicating the first person is not a target of identity determination. On the other hand, when the first determination unit 34 determines that the partial image indicating the first person is the target of person determination, the prevention unit 37 does not perform such prevention. Therefore, when the first determination unit 34 determines that the partial image indicating the first person is the target of person determination, the second determination unit 36 performs identity authentication for determining which of the candidates the first person is.

The authentication apparatus 30 has the above configuration.

Hereinafter, an authentication system 100 providing the same functions as the respective configurations of the authentication apparatus 30 will be described.

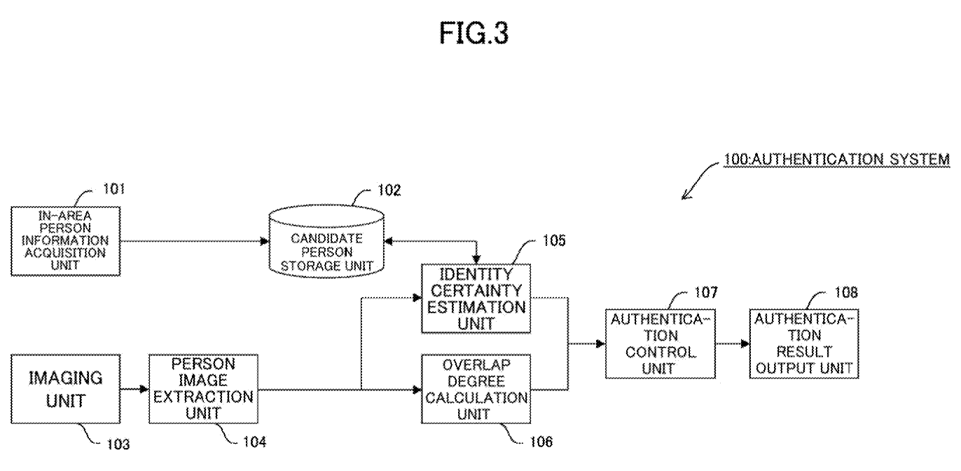

First, a first example of the authentication system 100 will be described. FIG. 3 illustrates a functional configuration of the first example of the authentication system 100.

The authentication system 100 of FIG. 3 includes an in-area person information acquisition unit 101, a candidate person storage unit 102, an imaging unit 103, a person image extraction unit 104, an identity certainty estimation unit 105, an overlap degree calculation unit 106, an authentication control unit 107, and an authentication result output unit 108.

The in-area person information acquisition unit 101 acquires information about a person located in a predetermined space, records the acquired person information in the candidate person storage unit 102, and stores the information, and provides functions corresponding to the acquisition unit 31 and the identification unit 32 in the authentication apparatus 30.

The candidate person storage unit 102 stores information about a person acquired by the in-area person information acquisition unit 101. The person whose information is stored in the candidate person storage unit 102 becomes a candidate for the person indicated by the query person image.

Here, a method of acquiring information about a person by the in-area person information acquisition unit 101 will be described.

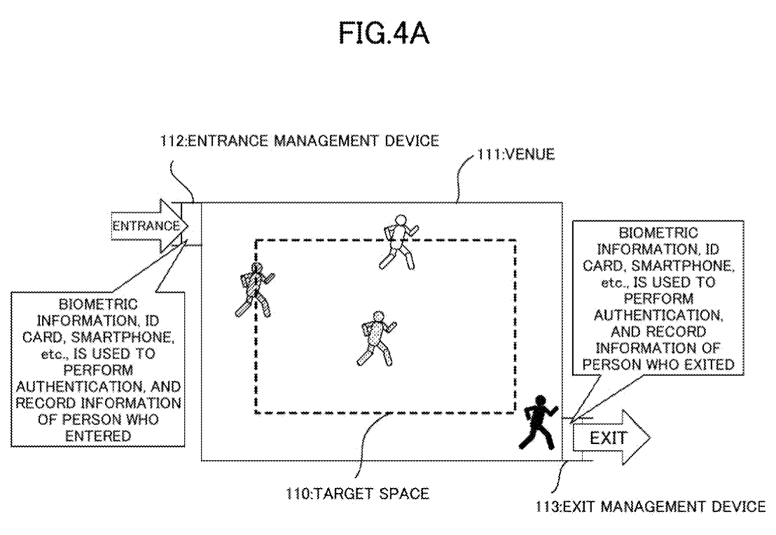

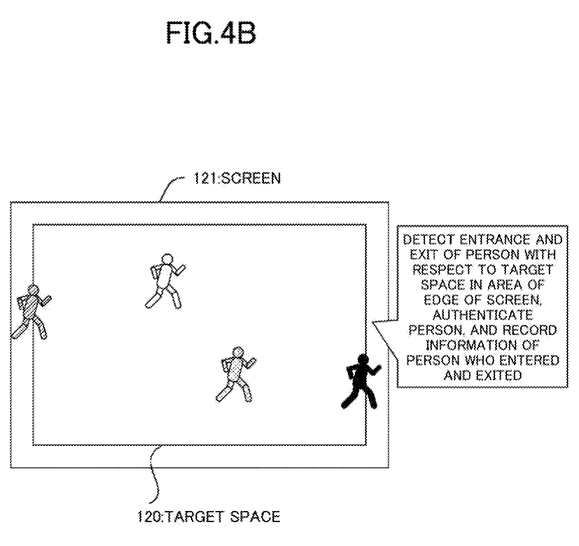

FIG. 4A illustrates a first example of a method of acquiring information about a person located in a predetermined space.

In the first example, an entrance management device 112 and an exit management device 113 as the in-area person information acquisition unit 101 are installed at the entrance and exit of a venue 111 including a target space 110 which is a predetermined space.

The entrance management device 112 includes a camera for capturing a person entering the venue 111. The entrance management device 112 authenticates the person entering the venue 111 by using biometric information of the entering person such as a face, palm vein, fingerprint, or the like, or authenticates the entering person by using an ID card or a smartphone owned by the entering person.

ID is an abbreviation of identification. The entrance management device 112 assigns identification information to an entering person for which the authentication has been successful, creates information in which the identification information is associated with an image feature amount obtained from a person image of the entering person captured by the camera, and stores and records the information as candidate information in the candidate person storage unit 102.

The exit management device 113 authenticates a person exiting the venue 111 in the same manner as was done by the entrance management device 112, and associates the exiting person with the entering person. Then, the exit management device 113 deletes, from the candidate person storage unit 102, information about the candidate who is the entering person associated with the exiting person.

FIG. 4B illustrates a second example of a method for acquiring information on a person located in a predetermined space.

FIG. 4B illustrates a screen 121 obtained by capturing a space including a target space 120 which is a predetermined space with a camera provided in the in-area person information acquisition unit 101. The in-area person information acquisition unit 101 performs detection of entry and exit of a person to and from the target space 120 and authentication of the entered person by, for example, face authentication or walking manner authentication, in an area of the edge of the screen 121 which is an outer peripheral portion of the target space 120. Then, the in-area person information acquisition unit 101 assigns identification information to the person for which the authentication has been successful, creates information in which the identification information is associated with an image feature amount obtained from the captured image of the person, records and stores the information as candidate information in the candidate person storing unit 102. The in-area person information acquisition unit 101 deletes information about the candidate who has exited the target space 120 from the candidate person storing unit 102.

The imaging unit 103 is a camera which captures a predetermined space such as the target space 110 in FIG. 4A and the target space 120 in FIG. 4B, for example, and obtains time-series images which are moving images. The camera functioning as the imaging unit 103 may also be used as the camera provided in the in-area person information acquisition unit 101.

The person image extraction unit 104 extracts a person image from each of the time-series images acquired by the imaging unit 103, and provides a function corresponding to the extraction unit 35 in the authentication apparatus 30. The person image extraction unit 104 extracts a person image from the image 10, which is 1 frame of the time-series images, based on a combination of a result of detecting the person image from the image 10 and a result of estimating the position of the person image in the image 10. Note that the position of the person image in the image 10 is estimated based on the position of the person image in each of the time-series images prior to the image 10.

Similarly to the description of the extraction unit 35, the person image extraction unit 104 estimates the position of the frame in the image 10 by using a motion vector obtained from the position of a frame (bounding box) surrounding the image of the person detected by the detection processing for the time-series images prior to the image 10. Then, the image of the person detected by the detection processing for the image 10 from the position closest to the estimated position, is extracted from the image 10. Furthermore, the person detected by the detection processing is associated, as the same person, with the person surrounded by the frame detected from the time-series images in the past, and the detected position of the person is set as the position of the frame on the image 10. In the present embodiment, the function of the person image extraction unit 104 is implemented by applying the above-described general technique similarly to the extraction unit 35.

The identity certainty estimation unit 105 estimates the identity certainty of each of the candidates whose image feature amounts are stored in the candidate person storing unit 102, which indicates the certainty of being the person indicated by the person image extracted by the person image extracting unit 104. More specifically, the identity certainty estimation unit 105 calculates the similarity between the image feature amount of the person image and the image feature amount of each of the candidates, and uses the calculated similarity.

The overlap degree calculation unit 106 calculates, as the overlap degree, the overlap degree between the area in the frame surrounding the person extracted from the image 10 by the person image extracting unit 104 and the area in the frame surrounding another person extracted from the image 10. The overlap degree calculation unit 106 provides a function corresponding to the calculation unit 33 in the authentication apparatus 30, and the overlap degree is an example of the above-described overlap degree.

As the overlap degree, the overlap degree calculation unit 106 may calculate, for example, IoU, which is the ratio of the common portion to the union of the two areas. Note that IoU is an abbreviation of Intersection over Union. Further, the overlap degree calculation unit 106 may obtain the depth information of the position of each person in a predetermined space, and calculate the IoU in the three-dimensional space by using the depth information to use it as the overlap degree. Further, the overlap degree calculation unit 106 may determine whether or not the two areas overlap, and calculate the overlap degree of the two areas only when the two areas overlap.

The authentication control unit 107 uses the person image extracted by the person image extraction unit 104 to determine which of the candidates whose image feature amounts are stored in the candidate person storage unit 102 the person (the first person) represented by the person image is. More specifically, the authentication control unit 107 uses the identity certainty estimation unit 105 to perform identity authentication by determining that the candidate with the highest identity certainty among the candidates is the first person. That is, the authentication control unit 107 provides a function corresponding to the second determination unit 36 in the authentication apparatus 30.

However, the authentication control unit 107 determines whether the overlap degree calculated by the overlap degree calculation unit 106 is higher than a predetermined threshold with respect to the person image of the first person extracted by the person image extraction unit 104. This threshold is determined to be an upper limit value of the overlap degree when the execution of identity authentication with respect to the person image is permitted. That is, the authentication control unit 107 also provides a function corresponding to the first determination unit 34 in the authentication apparatus 30.

In the above-described determination, when the calculated overlap degree is determined to be higher than the predetermined threshold, the authentication control unit 107 prevents the determination as to which of the candidates the person indicated in the person image is. That is, at this time, the authentication control unit 107 does not execute the above-described identity authentication for the person indicated in the person image extracted from the image 10. That is, the authentication control unit 107 also provides a function corresponding to the prevention unit 37 in the authentication apparatus 30.

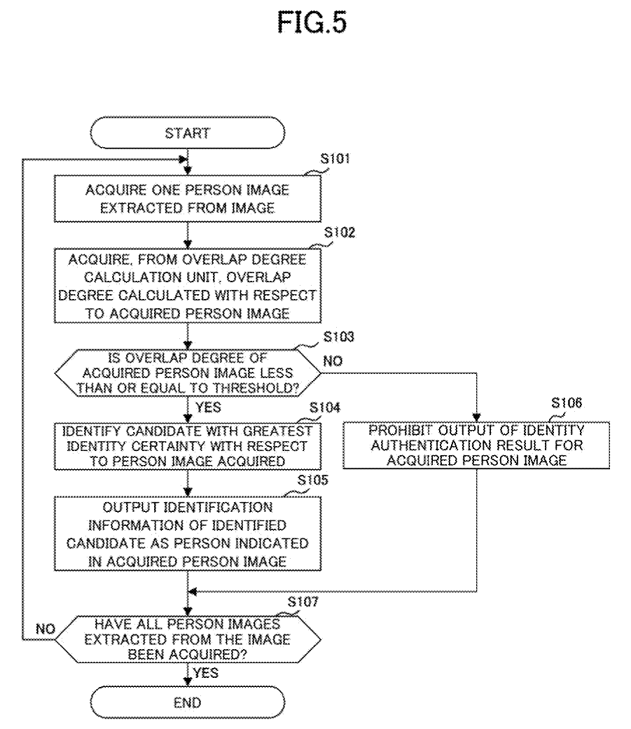

The authentication control processing performed by the authentication control unit 107 will now be described in detail. FIG. 5 is a flowchart illustrating the processing contents of the first example of the authentication control processing.

When the processing illustrated in FIG. 5 is started, first, in step S101, a process for acquiring one person image extracted from the image 10 by the person image extraction unit 104 is performed.

Next, in step S102, a process for acquiring the overlap degree calculated by the overlap degree calculation unit 106 with respect to the person image acquired by the processing in step S101 is performed.

Next, in step S103, a process for determining whether or not the overlap degree of the person image acquired by the process in step S101 and the person image, acquired by the process in step S102, is less than or equal to the threshold is performed. In this determination process, when it is determined that the overlap degree is less than or equal to the threshold (when the determination result is YES), the process proceeds to step S104. On the other hand, in this determination process, when it is determined that the overlap degree is higher than the threshold (when the determination result is NO), the process proceeds to step S106. This determination process is a process for providing the function of the first determination unit 34 in the authentication apparatus 30.

The processes in steps S104 and S105 are processes for handling the person image acquired by the process in step S101 as a query person image, for authenticating the person (the first person) illustrated in the query person image, and for outputting the authentication result.

In step S104, among the candidates whose image feature amounts are stored in the candidate person storage unit 102, a process is performed for identifying the candidate with the greatest identity certainty as the person (the first person) indicated in the person image acquired by the process in step S101. The identity certainty is a value estimated by the identity certainty estimation unit 105. This process is a process for determining which of the candidates whose image feature amounts are stored in the candidate person storage unit 102 the first person is, and provides the function of the second determination unit 36 in the authentication apparatus 30.

In step S105, a process is performed to make the authentication result output unit 108 output identification information about the candidate as the first person identified by the process in step S104. After this process, the process proceeds to step S107.

On the other hand, in step S106, a process is performed to prohibit the authentication result output unit 108 from outputting the result of the identity authentication without executing the identity authentication process (processes in steps S104 and S105) for the first person indicated in the person image acquired by the process in step S101. This process in step S106 is a process to prevent the person image acquired by the process in step S101 from being handled as the query person image, and is a process to provide the function of the prevention unit 37 in the authentication apparatus 30.

In step S107, a process is performed to determine whether all the person images extracted from the image 10 by the person image extraction unit 104 have been acquired by the process in step S101. In this determination process, when it is determined that all the person images have been acquired (when the determination result is YES), the authentication control process is ended and execution of the authentication control process for the next image 10 in the time-series images is awaited. On the other hand, in this determination process, when it is determined that unacquired person images remain (when the determination result is NO), the process returns to step S101, and the processes in step S101 and subsequent steps are performed again for the unacquired person images.

The above processing is a first example of the authentication control processing.

The authentication system 100 illustrated in FIG. 3 includes the above-described components, so that when the overlap between a person image and another person image is large, the person image is not treated as a query image, and the identity authentication of the person in the person image is prevented. Therefore, as a result, the accuracy of the identity authentication is improved.

Next, a second example of the authentication system 100 will be described.

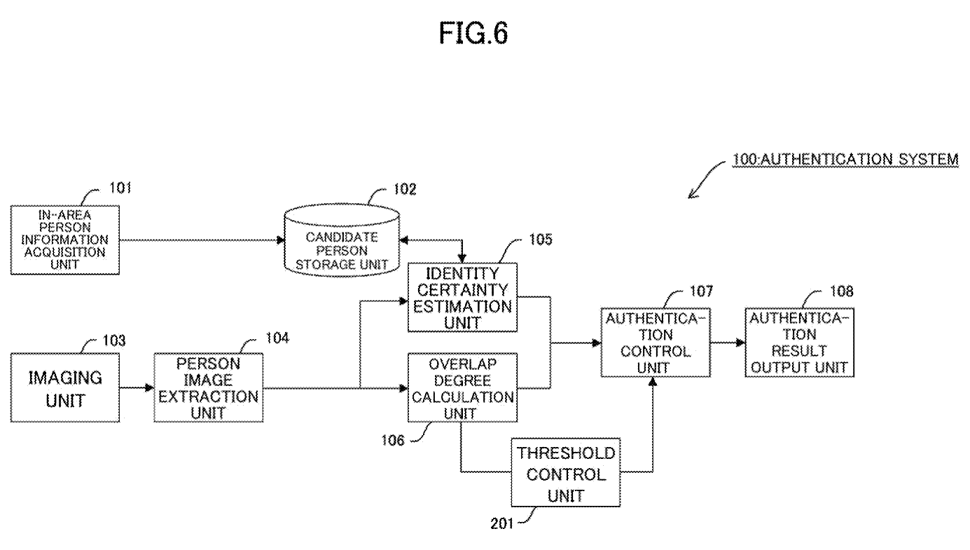

FIG. 6 illustrates the functional configuration of the second example of the authentication system 100. In FIG. 6, components providing the same functions as those provided in the first example of FIG. 3 are denoted by the same reference numerals, and a detailed description of these components will be omitted.

The second example illustrated in FIG. 6 has a configuration in which a threshold control unit 201 is added to the configuration of the first example illustrated in FIG. 3.

It has already been described with reference to FIG. 1 that the accuracy of identity authentication decreases when the overlap between a person image and another person image is large. In addition, if this case continues, the reliability of past information decreases, resulting in reduced accuracy of person image extraction by the person image extraction unit 104.

Therefore, the threshold control unit 201 performs control to change the threshold of the determination for the frame next to one frame according to the result of the determination of the size of overlap between the person image extracted from the one frame of the time-series images and another person image. More specifically, when it is determined that the person image is not treated as a query image, the threshold control unit 201 changes the threshold of the size determination reference for the person image extracted from the next time-series image following the time-series image from which the person image is extracted, to a lower value.

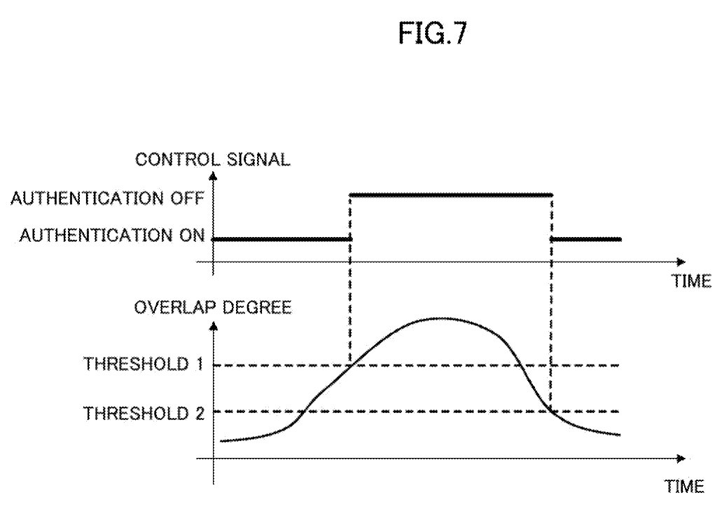

This change of the threshold will be described with reference to FIG. 7.

The lower waveform illustrated in FIG. 7 illustrates an example of the time variation of the overlap degree of a person image. At the start position of this waveform, the threshold of the reference for determining the size of the overlap degree in the determination processing in step S103 of the flowchart illustrated in FIG. 5 is “threshold 1”.

Thereafter, when the overlap degree increases to reach “threshold 1”, the control signal changes from “authentication ON” to “authentication OFF” as indicated by the upper waveform. The control signal represents a signal for performing control for switching between execution and prevention of identity authentication. Note that “authentication ON” represents a control signal corresponding to a state in which identity authentication is executed, and “authentication OFF” represents a control signal corresponding to a state in which identity authentication is prevented.

When the overlap degree increases to reach “threshold 1”, the authentication control unit 107 changes the control signal from “authentication ON” to “authentication OFF”. In the flowchart illustrated in FIG. 5, at this time, the result of the determination process in step S103 changes from YES to NO, and the authentication control unit 107 executes the process in step S106 to prevent execution of identity authentication. At this time, the threshold control unit 201 changes the threshold of the reference for determining the overlap degree in the determination process at S103 from “threshold 1” to “threshold 2” which is lower than “threshold 1”.

Thereafter, during a period when the overlap degree is higher than “threshold 2”, the authentication control unit 107 continues to prevent the execution of the identity authentication, but when the overlap degree decreases and reaches “threshold 2”, the authentication control unit 107 changes the control signal from “authentication OFF” to “authentication ON”. In the flowchart illustrated in FIG. 5, at this time, the result of the determination process at S103 changes from “NO” to “YES”, and the authentication control unit 107 executes the processes at S104 to S105 to execute the identity authentication. At this time, the threshold control unit 201 returns the threshold of the reference for determining the overlap degree in the determination process at S103 from “threshold 2” to “threshold 1” before the change.

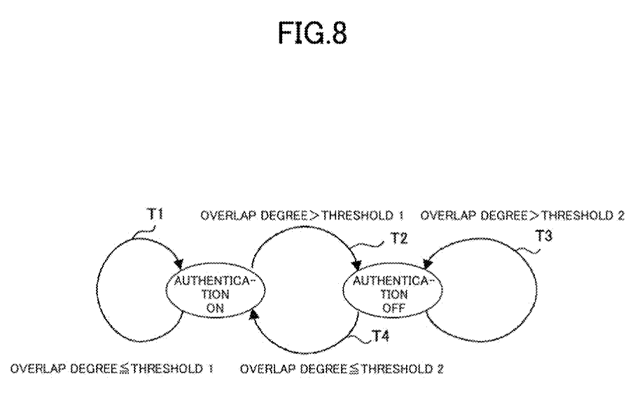

FIG. 8 illustrates a state transition between the execution and prevention of the identity authentication caused by the change of the threshold.

In FIG. 8, the state “authentication ON” represents a state in which the identity authentication is executed by the authentication control unit 107, and the state “authentication OFF” represents a state in which the execution of the identity authentication by the authentication control unit 107 is prevented. As described above, the “threshold 2” is lower than the “threshold 1”.

In FIG. 8, in the “authentication ON” state, the “authentication ON” state is continued as long as the overlap degree is less than or equal to the “threshold 1” (arrow T1), but when the overlap degree is higher than the “threshold 1”, the state shifts to the “authentication OFF” state (arrow T2). In the “authentication OFF” state, the “authentication OFF” state is continued as long as the overlap degree is higher than the “threshold 2” (arrow T3), but when the overlap degree is higher than the “threshold 2”, the state shifts to the “authentication ON” state (arrow T4).

In this way, when it is determined that the person image indicating the first person included in the first image, which is one of the time-series images, is not to be the target of person determination, the threshold control unit 201 changes the threshold used for determining whether the person image is to be the target of person determination to a value lower than the value before the change. Then, by using the changed threshold, the authentication control unit 107 determines whether the partial image indicating the first person included in the second image, which is the time-series image following the first image, is to be the target of person determination. Thereafter, when it is determined that the partial image indicating the first person included in the second image is to be the target of person determination, the threshold control unit 201 changes the threshold used for determining whether the person image is to be the target of person determination, back to the value before the change. Then, by using the changed threshold, the authentication control unit 107 determines whether the partial image indicating the first person included in the third image, which is the time-series image following the second image, is to be the target of person determination.

In this way, after it is once determined that the extracted person image is not to be handled as the query image, the determination standard for whether or not the person image is to be handled as the query image is raised to make the conditions for executing the identity authentication stricter, thereby improving the accuracy of the identity authentication.

The threshold may be changed continuously by using, for example, a smoothing filter instead of switching between two discrete values. The overlap degree may also be determined to be higher or lower than the threshold by using a value smoothed against a time change.

Next, a third example of the authentication system 100 will be described.

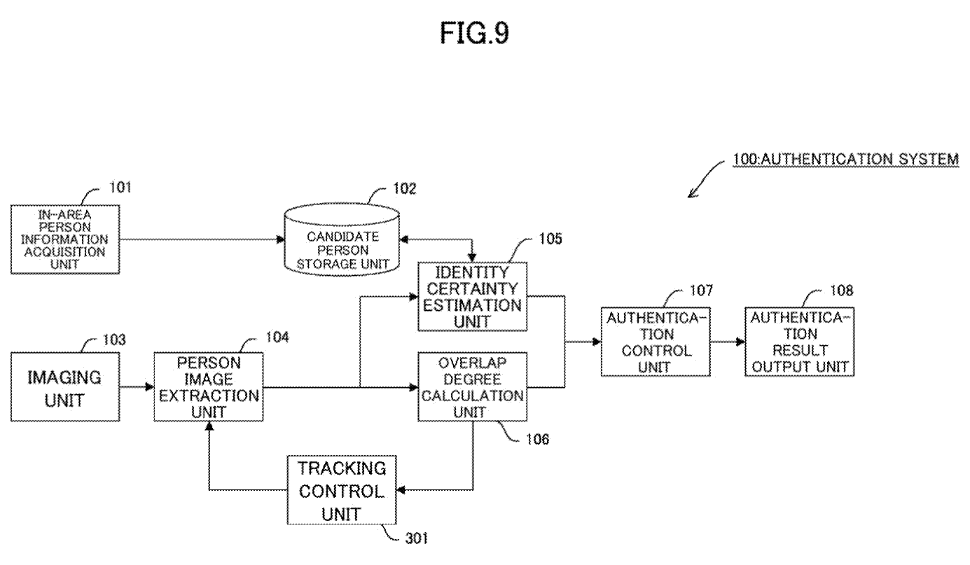

FIG. 9 illustrates a functional configuration of the third example of the authentication system 100. In FIG. 9, the same components as those provided in the first example of FIG. 3 are denoted by the same reference numerals, and a detailed description of these components will be omitted.

The third example of FIG. 9 has a configuration in which a tracking control unit 301 is added to the configuration of the first example illustrated in FIG. 3.

As described above, the person image extraction unit 104 extracts a person image from the image 10. This extraction is performed based on a combination of the result of the detection of the person image from the image 10 and the result of the estimation of the position of the person image in the image 10 based on the position of the person image in each of the time-series images prior to the image 10. More specifically, the person image extraction unit 104 estimates the position of a frame in the image 10 by using a motion vector obtained from the position of the frame (bounding box) surrounding the image of the person detected by the detection processing for the time-series image prior to the image 10. Further, the person detected by the detection processing is associated, as the same person, with the person surrounded by the frame detected from the time-series image in the past, and the detection position of the person is set as the position of the frame on the image 10.

However, if the overlap between the person image and another person image is large, the accuracy of the detection of the person by the detection processing is reduced. At this time, if the detection position of the detected person is set as the position of the frame on the image 10, the estimation accuracy in the estimation processing of the position of the frame in the next frame following the image 10 in the time-series images is reduced.

Therefore, if the overlap between the person image and another person image is large, the tracking control unit 301 sets the estimated position of the frame as the position of the frame on the image 10 as it is. That is, in this case, the estimated position of the frame is not compensated by the position of the image of the person detected by the detection processing, and the influence of the reduction in the estimation accuracy of the position of the frame in the next frame following the image 10 is prevented.

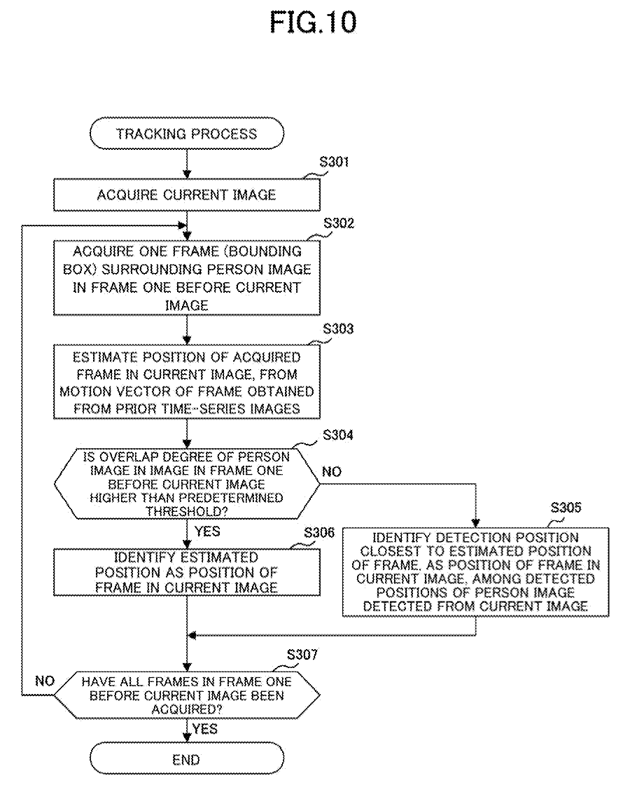

FIG. 10 will be described below. FIG. 10 is a flowchart illustrating the processing contents of one example of the tracking processing.

Among the processes illustrated in FIG. 10, the processes at steps S304 and S306 are characteristic in the third example of the authentication system 100. On the other hand, the other processes are also performed by the person image extracting unit 104 in the first and second examples described above.

When the processing illustrated in FIG. 10 is started, first, at step S301, a process for acquiring the latest image 10 of the time-series images as moving images obtained by the imaging unit 103, is performed. Hereinafter, the image 10 acquired by the process at step S101 is referred to as a “current image”.

In step S302, a process is performed to acquire one frame (bounding box) surrounding the person image in the frame one before the current image acquired in step S301 among the time-series images obtained by the imaging unit 103.

In step S303, a process is performed to estimate the position of the frame acquired in step S302 in the current image, from a motion vector obtained from the position of the frame in each of the time-series images prior to the current image.

In step S304, a process is performed to determine whether the overlap degree of the person image surrounded by the frame acquired in step S302, in the current image calculated by the overlap degree calculation unit 106, is higher than a predetermined threshold. The threshold is the same as the threshold used by the authentication control unit 107 to determine whether or not the person image is to be authenticated.

In the determination process in step S304, when it is determined that the overlap degree is higher than the threshold (when the determination result is YES), the process proceeds to step S306, and when it is determined that the overlap degree is less than or equal to the threshold (when the determination result is NO), the process proceeds to step S305.

In step S305, a process is performed to identify the position closest to the estimated position of the frame in step S303, as the position of the frame in the current image, among the detected positions of the person image detected from the current image by the detection process performed together with tracking in the person image extracting unit 104. Thereafter, the process proceeds to step S307.

Step S306 is a process in the case where it is determined by the determination process in step S304 that the person image surrounded by the frame acquired by the process in step S302 is not used for the identity authentication in the current image. In step S306, a process is performed to identify the estimated position of the frame by the process in step S303 as the position of the frame in the current image. That is, in step S306, the estimated position of the frame is not compensated by the detection position of the person image detected from the current image by the detection process performed by the person image extracting unit 104.

In step S307, a process is performed to determine whether all the frames in the frame one before the current image have been acquired by the process in step S302. In this determination process, when it is determined that all the frames have been acquired (when the determination result is YES), the tracking process is ended and the acquisition of a new image following the current image by the imaging unit 103 is awaited. On the other hand, in this determination process, when it is determined that an unacquired frame remains (when the determination result is NO), the process returns to step S302 and the processes in step S102 and subsequent steps are performed again for the unacquired frame.

The above processing is the tracking processing. Note that the determination process at step S304 in FIG. 10 is the processing performed by the tracking control unit 301 in FIG. 9, and the other processes are the processes performed by the person image extraction unit 104 in FIG. 9.

As described above, in the third example of the authentication system 100, when it is determined that the person image is not a target of the person determination, the extraction of the person image from the second image following the first image from which the person image is extracted is performed by using only the result of the estimation of the position of the person image in the second image. This estimation is performed based on the position of the person image in each of the time-series images prior to the second image, and the result of the detection of the person image from the second image is not used for the extraction of the person image from the second image. Thus, in the third example of the authentication system 100, the degrading of the estimation accuracy in the estimation of the position of the partial image included in the image later than the second image in the time-series images is prevented.

Next, a fourth example of the authentication system 100 will be described.

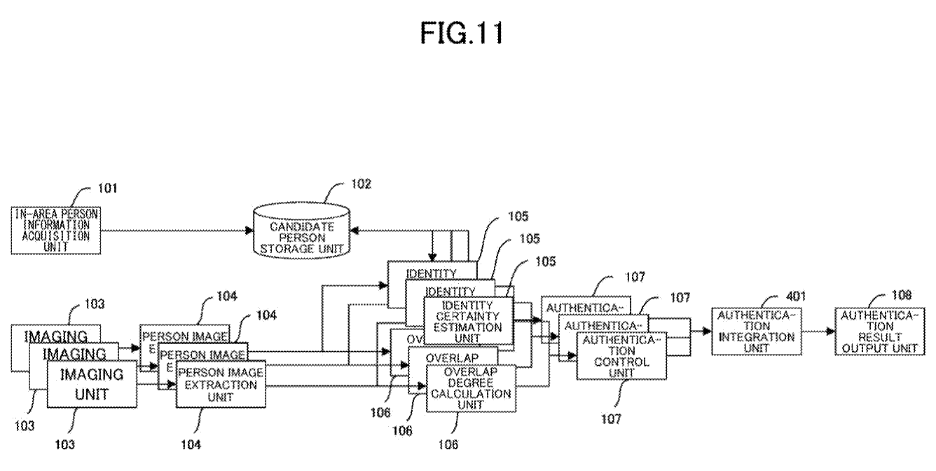

FIG. 11 illustrates the functional configuration of the second example of the authentication system 100. In FIG. 11, components providing the same functions as those provided in the first example of FIG. 3 are denoted by the same reference numerals, and a detailed description of these components will be omitted.

The structural difference in the fourth example of FIG. 11 from the first example is that a plurality of each of the imaging unit 103, the person image extracting unit 104, the identity certainty estimating unit 105, the overlap degree calculation unit 106, and the authentication control unit 107 are provided, and an authentication integration unit 401 is added. In FIG. 11, for convenience, three of each of the imaging unit 103, the person image extracting unit 104, the identity certainty estimating unit 105, the overlap degree calculation unit 106, and the authentication control unit 107 are illustrated.

All of the plurality of imaging units 103 are cameras for capturing a predetermined space to obtain time-series images as moving images, and are arranged so as to capture the predetermined space from different capturing positions.

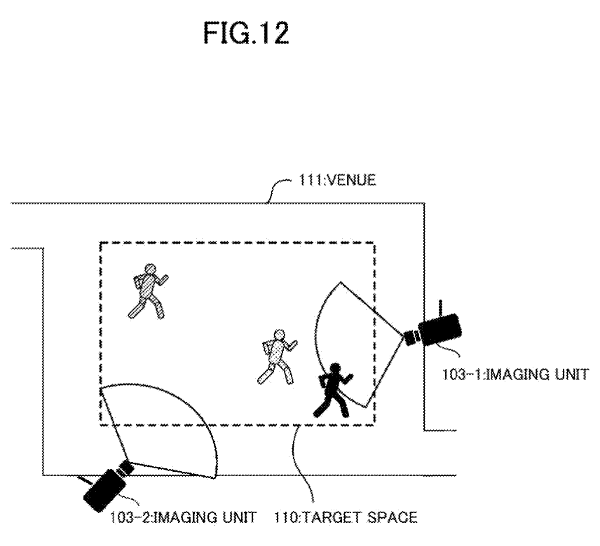

FIG. 12 illustrates an example of installation of the plurality of imaging units 103, and schematically illustrates an example of installation in a venue 111 including a target space 110 as a predetermined space illustrated in FIG. 4A. In FIG. 12, the imaging units 103-1 and 103-2 are installed at different positions, and the target space 110 is captured from the respective installation positions.

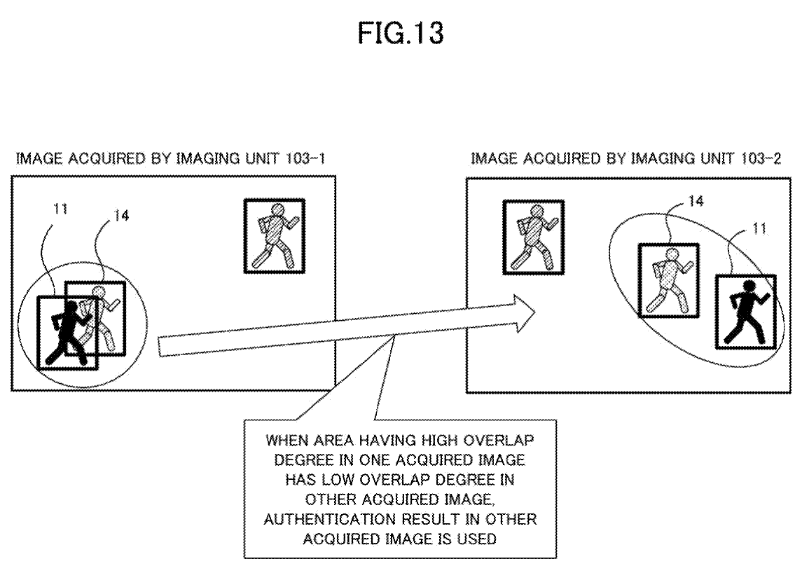

When the overlap with respect to the person image included in the image 10 captured by one of the imaging units 103 is large, the authentication integration unit 401 adopts and outputs the result of the identity authentication for the person image performed by using the image 10 captured by another one of the imaging units 103. The operation of the authentication integration unit 401 will be described with reference to FIG. 13.

FIG. 13 illustrates an image example of an acquired image obtained by capturing the target space 110 by the imaging units 103-1 and 103-2 for which the installation example is illustrated in FIG. 12. In the image acquired by the imaging unit 103-1, the person image 14 largely overlaps the person image 11. On the other hand, the person image 14 in the image acquired by the imaging unit 103-2 does not overlap and the overlap degree is zero.

In such a case, the authentication integration unit 401 adopts the result of the identity authentication performed by using the image acquired by the imaging unit 103-2 having a small overlap with respect to the person image 14, and causes the authentication result output unit 108 to output the result of the adopted identity authentication. Thus, even when the overlap of the person images is large, degrading of the accuracy of the identity authentication is prevented.

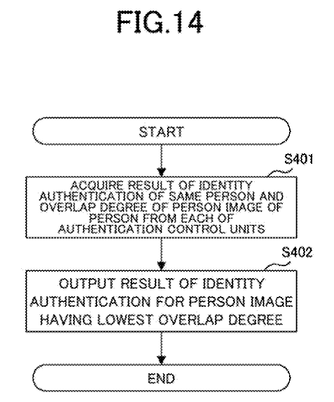

The authentication control processing performed by the authentication integration unit 401 will be described in detail. FIG. 14 is a flowchart illustrating the processing contents of an example of the integrated authentication processing.

When the processing illustrated in FIG. 14 is started, in step S401, processing is performed to acquire the result of the identity authentication of the same person and the overlap degree of the person image of the person from the plurality of authentication control units 107. The association of the person images acquired from each of the plurality of imaging units 103 may be performed based on the distance obtained by a distance sensor and the installation position of each imaging unit 103 by using, for example, the distance sensor for acquiring the distance from each imaging unit 103 to the person.

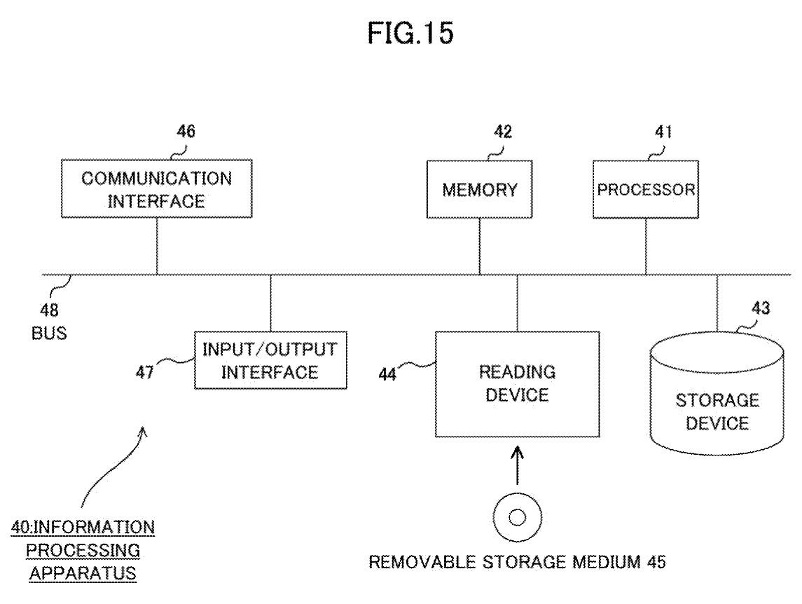

In step S402, processing is performed to cause the authentication result output unit 108 to output the result of the identity authentication acquired in step S401 for the person of the person image having the lowest overlap degree acquired in step S401, and then the processing illustrated in FIG. 15 is completed.

The processing up to the above is the integrated authentication processing.

As described above, in the fourth example of the authentication system 100, a second image, which is different from the first image obtained by capturing a predetermined space, and which is obtained by capturing a predetermined space from a capturing position different from the capturing position of the first image, is acquired. Then, the overlap degree between the first person and the other person appearing in the first image is calculated as the first overlap degree, and another overlap degree which is the overlap degree between the first person and the other person appearing in the second image is calculated as the second overlap degree.

In the fourth example, according to the first overlap degree, it is determined whether or not the person image (partial image) indicating the first person included in the first image is to be a target of person determination. When it is determined that the person image indicating the first person included in the first image is to be a target of person determination, it is determined which of the candidates the first person is by using the person image indicating the first person included in the first image.

In the fourth example, further, according to the second overlap degree, it is determined whether or not the person image (another partial image) indicating the first person included in the second image is to be a target of person determination. When it is determined that the person image indicating the first person included in the second image is to be a target of person determination, it is determined which of the candidates the first person is by using the person image indicating the first person included in the second image.

In the fourth example, when the second overlap degree is lower than the first overlap degree, it is determined which of the candidates the first person is by using the person image indicating the first person included in the second image, and the determination result is output. On the other hand, when the first overlap degree is lower than the second overlap degree, it is determined which of the candidates the first person is, is output by using the person image indicating the first person included in the first image, and the determination result is output.

In the fourth example of the authentication system 100, even when the overlap of the person images is large, the degrading of the accuracy of the identity authentication is prevented.

Next, FIG. 15 will be described. FIG. 15 illustrates an example of the hardware configuration of an information processing apparatus 40. The information processing apparatus 40 can function as the candidate person storage unit 102, the person image extraction unit 104, the identity certainty estimation unit 105, the overlap degree calculation unit 106, the authentication control unit 107, and the authentication result output unit 108 in the examples of the authentication system 100 described above. The information processing apparatus 40 can also function as the threshold control unit 201 in the second example of the authentication system 100, the tracking control unit 301 in the third example of the authentication system 100, and the authentication integration unit 401 in the fourth example of the authentication system 100.

The information processing apparatus 40 includes hardware components such as a processor 41, a memory 42, a storage device 43, a reading device 44, a communication interface 46, and an input/output interface 47. These components are connected via a bus 48, and data can be exchanged between the components.

The processor 41 may be, for example, a single processor, a multi-processor, or a multi-core. The processor 41 functions as the above-mentioned components in the above-mentioned authentication system 100 by executing a program using the memory 42.

The memory 42 is, for example, a semiconductor memory, and may include a RAM area and a ROM area. RAM is an abbreviation of Random Access Memory. ROM is an abbreviation of Read Only Memory.

The storage device 43 is, for example, a semiconductor memory such as a flash memory or a hard disk device, in which the object model and the terminal model described above are stored in advance.

The reading device 44 accesses a removable storage medium 45 according to instructions from the processor 41. The removable storage medium 45 is implemented by, for example, a semiconductor device (USB memory or the like), a medium on which information is input/output by magnetic action (magnetic disk or the like), a medium on which information is input/output by optical action (CD-ROM, DVD, etc.), or the like. USB is an abbreviation of Universal Serial Bus. CD is an abbreviation of Compact Disc. DVD is an abbreviation of Digital Versatile Disk.

The communication interface 46 transmits and receives data via a communication network (not illustrated) according to instructions from the processor 41, for example.

The input/output interface 47 provides interfaces with the in-area person information acquisition unit 101 and the imaging unit 103, for example. The input/output interface 47 provides the function of the authentication result output unit 108 in combination with an output device such as a display device.

As described above, the hardware configuration of the information processing apparatus 40 is similar to that of a standard computer. Therefore, a computer may be used as the information processing apparatus 40.

A program to be executed by the processor 41 of the information processing apparatus 40 is provided, for example, in the following form.

(1) Preinstalled in the storage device 43.

(2) Provided by the removable storage medium 45.

(3) Provided to the communication interface 46 via a communication network (not illustrated) from a server such as a program server.

The hardware configuration of the information processing apparatus 40 is exemplary, and the embodiments are not limited thereto. For example, some or all of the functions of the above-described functional units may be implemented as hardware by FPGA and SoC. FPGA is an abbreviation of Field Programmable Gate Array. SoC is an abbreviation of System-on-a-Chip.

The above-described authentication system 100 is useful when used in, for example, an airport. In an airport where a large number of people come and go, there is a concern that the accuracy of person authentication may be degraded due to the occurrence of occlusion. In such a situation, the use of the authentication system 100 can reduce the possibility of erroneous authentication of the target person being authenticated due to occlusion. Therefore, for example, it is expected to prevent inappropriate provision of services such as displaying a boarding gate guide of another person who has been misidentified as the passenger on an electronic guide board for guiding passengers to the boarding gate.

Although the disclosed embodiments and their advantages have been described in detail above, those skilled in the art may make various changes, additions, and omissions without departing from the scope of the present invention clearly described in the appended claims.

For example, the threshold control unit 201 in the second example of the authentication system 100 may be added to the functional configuration of the third example of the authentication system 100 illustrated in FIG. 9, and the threshold of the reference for determining the size of the overlap may be changed in the third example in the same manner as in the second example.

The threshold control unit 201 in the second example of the authentication system 100 may be added between the authentication control units 107 each corresponding to one of the plurality of overlap degree calculation units 106 in the functional configuration of the fourth example of the authentication system 100 illustrated in FIG. 11. That is, the threshold of the reference for determining the size of the overlap performed by each of the plurality of authentication control units 107 may be changed in the same manner as in the second example.

The tracking control unit 301 in the third example of the authentication system 100 may be added between the person image extraction units 104 each corresponding to one of the plurality of overlap degree calculation units 106 in the functional configuration of the fourth example of the authentication system 100 illustrated in FIG. 11. That is, the tracking performed by each of the plurality of person image extraction units 104 may be controlled.

According to one aspect, it is possible to easily guide the subject and the terminal to a desired positional relationship.

The present invention is not limited to the specific embodiments described herein, and variations and modifications may be made without departing from the scope of the present invention.

All examples and conditional language recited herein are intended for pedagogical purposes to aid the reading device in understanding the invention and the concepts contributed by the inventor to furthering the art, and are to be construed as being without limitation to such specifically recited examples and conditions, nor does the organization of such examples in the specification relate to an illustration of the superiority and inferiority of the invention. Although the embodiments of the present invention have been described in detail, it should be understood that the various changes, substitutions, and alterations could be made hereto without departing from the spirit and scope of the invention.

What is claimed is:

1. A determination method executed by a processor in a computer, the determination method comprising:
calculating, by the processor, an overlap degree between a first person and another person among a plurality of persons, in response to detecting that the plurality of persons are appearing in an image obtained by capturing a predetermined space;
determining, by the processor, whether or not a partial image included in the image and indicating the first person is to be a target of person determination, according to the calculated overlap degree;
determining, by the processor, which of candidates the first person is, by using the partial image, in response to determining that the partial image is to be the target of the person determination; and
preventing, by the processor, the determining of which of the candidates the first person is, by using the partial image, in response to determining that the partial image is not to be the target of the person determination.

2. The determination method according to claim 1, further comprising:
acquiring, by the processor, information of a person located in the predetermined space; and
identifying, by the processor, the candidate based on the information of the person.

3. The determination method according to claim 1, wherein
the image is a first image that is one of time-series images obtained by continuously capturing the predetermined space, and
the determining of whether or not the partial image indicating the first person is to be the target of the person determination, includes determining that the partial image indicating the first person is not to be the target of the person determination, in response to determining that the overlap degree is higher than a predetermined threshold,
the determination method further comprising:
determining, by the processor, whether or not a partial image indicating the first person included in a second image is to be the target of the person determination, the second image being an image following the first image among the time-series images, upon changing the predetermined threshold to a value lower than an original value before being changed, in response to determining that the partial image indicating the first person included in the first image is not to be the target of the person determination.

4. The determination method according to claim 3, further comprising:
determining, by the processor, whether or not a partial image indicating the first person included in a third image is to be the target of the person determination, the third image being an image following the second image among the time-series images, upon changing the value of the predetermined threshold back to the original value before being changed, in response to determining that the partial image indicating the first person included in the second image is to be the target of the person determination.

5. The determination method according to claim 1, wherein
the image is a first image that is one of time-series images obtained by continuously capturing the predetermined space,
the determination method further comprising:
extracting, by the processor, from the first image, the partial image included in the first image, based on a combination of a result of detecting a person image from the first image and a result of estimating a position of the partial image in the first image based on a position of the partial image in each of the time-series images prior to the first image; and
extracting, by the processor, from a second image, a partial image included in the second image, the second image being an image following the first image among the time-series images, by using only a result of estimating a position of the partial image in the second image, among a result of detecting a person image from the second image and the result of estimating the position of the partial image in the second image based on a position of the partial image each of the time-series images prior to the second image, in response to determining that the partial image indicating the first person included in the first image is not to be the target of the person determination.

6. The determination method according to claim 1, further comprising:
calculating, by the processor, as another overlap degree, an overlap degree between the first person appearing in another image different from the image and another person appearing in the other image, the other image being obtained by capturing the predetermined space from a capturing position different from a capturing position of the image; and
determining, by the processor, whether another partial image included in the other image indicating the first person, is to be the target of the person determination, according to the calculated other overlap degree.

7. The determination method according to claim 6, further comprising:
determining, by the processor, which of the candidates the first person is, by using the other partial image, in response to determining that other partial image is to be the target of the person determination.

8. The determination method according to claim 7, further comprising:
outputting, by the processor, a determination result of which of the candidates the first person is, determined by using the other partial image, in response to determining that the other overlap degree is lower than the overlap degree; and
outputting, by the processor, a determination result of which of the candidates the first person is, determined by using the partial image, in response to determining that the overlap degree is lower than the other overlap degree.

9. A non-transitory computer-readable recording medium storing a program that causes a computer to execute a process, the process comprising:
calculating an overlap degree between a first person and another person among a plurality of persons, in response to detecting that the plurality of persons are appearing in an image obtained by capturing a predetermined space;
determining whether or not a partial image included in the image and indicating the first person is to be a target of person determination, according to the calculated overlap degree;
determining which of candidates the first person is, by using the partial image, in response to determining that the partial image is to be the target of the person determination; and
preventing the determining of which of the candidates the first person is, by using the partial image, in response to determining that the partial image is not to be the target of the person determination.

10. An information processing apparatus comprising:
a processor configured to execute a process including
calculating an overlap degree between a first person and another person among a plurality of persons, in response to detecting that the plurality of persons are appearing in an image obtained by capturing a predetermined space;
determining whether or not a partial image included in the image and indicating the first person is to be a target of person determination, according to the calculated overlap degree;
determining which of candidates the first person is, by using the partial image, in response to determining that the partial image is to be the target of the person determination; and
preventing the determining of which of the candidates the first person is, by using the partial image, in response to determining that the partial image is not to be the target of the person determination.
